(19) United States
(12) Patent Application Publication
(10) Pub. No.: US 2016/0156165 A1
(43) Pub. Date: Jun. 2, 2016

(54) PROTECTOR AND WIRING HARNESS WITH PROTECTOR

(71) Applicants: AUTONETWORKS TECHNOLOGIES, LTD., Yokkaichi, Mie (JP); SUMITOMO WIRING SYSTEMS, LTD., Yokkaichi, Mie (JP); SUMITOMO ELECTRIC INDUSTRIES, LTD., Osaka-shi, Osaka (JP)

(72) Inventors: Shigeto KATOU, Mie (JP); Atsushi MURATA, Mie (JP)

(73) Assignees: AutoNetworks Technologies, Ltd., Yokkaichi, Mie (JP); Sumitomo Wiring Systems, Ltd., Yokkachi, Mie (JP); Sumitomo Electronic Industries, Ltd., Osaka-shi, Osaka (JP)

(21) Appl. No.: 14/900,333

(22) PCT Filed: Jun. 11, 2014
(86) PCT No.: PCT/JP2014/065466

§ 371 Date: Dec. 21, 2015

(30) Foreign Application Priority Data
Jul. 1, 2013 (JP) 2013-137685

(51) Int. Cl. H02G 3/00; H01B 7/00

(52) U.S. Cl. CPC H02G 3/26; H01B 7/0045

(57) ABSTRACT

It is aimed to provide a technology capable of partially easily bending and deforming a wiring harness accommodated in a protector without introducing a hot-pressing machine for forming a shape capable of accommodating a wiring harness at a manufacturing side for wiring harnesses. To achieve this object, a protector includes an accommodating portion formed of a sheet material obtained by partially pressing a flexible sheet-like nonwoven material containing basic fibers and a binder having a lower melting point than the basic fibers from opposite sides and heating at least one surface of a pressed part, thereby having a cured partial area, and having an internal space capable of accommodating a wiring harness. The accommodating portion includes a hard portion and a soft portion softer than the hard portion along a longitudinal direction.

### TECHNICAL FIELD

The present invention relates to a protector for accommodating a wiring harness.

### BACKGROUND ART

A protector of patent literature 1 is formed to have a part having a high rigidity and an easily bendable bending allowed part along an accommodating direction of a wiring harness by hot-pressing a nonwoven fabric covering the wiring harness from an outer peripheral side. According to the protector of patent literature 1, the accommodated wiring harness can be partially easily bent and deformed.

### CITATION LIST

### Patent Literature

Patent literature 1:
Japanese Unexamined Patent Publication No. 2011-160611

### SUMMARY OF THE INVENTION

### Technical Problem

However, since the protector of patent literature 1 is formed by hot-pressing the nonwoven fabric in a state covering the wiring harness from the outer peripheral side, it is necessary to introduce a hot-pressing machine for forming a shape capable of accommodating a wiring harness at a manufacturing site for wiring harnesses, presenting a problem of increasing a working space and a work burden.

The present invention was developed to solve such a problem and aims to provide a technology capable of partially easily bending and deforming a wiring harness accommodated in a protector without introducing a hot-pressing machine for forming a shape capable of accommodating a wiring harness at a manufacturing side for wiring harnesses.

### Solution to Problem

To solve the above problem, a protector according to a first aspect includes an accommodating portion formed of a sheet material obtained by partially pressing a flexible sheet-like nonwoven material containing basic fibers and a binder having a lower melting point than the basic fibers from opposite sides and heating at least one surface of a pressed part, thereby having a cured partial area, and having an internal space capable of accommodating a wiring harness, and the accommodating portion includes a hard portion and a soft portion softer than the hard portion along a longitudinal direction.

A protector according to a second aspect is the protector according to the first aspect, the accommodating portion is formed into a gutter shape including a bottom portion and a pair of side walls projecting toward the same side from opposite sides of the bottom portion, and the protector further includes a lid portion having one end rotatably provided on one of the pair of side walls of the accommodating portion and capable of closing an opening of the accommodating portion.

A protector according to a third aspect is the protector according to the first or second aspect, and at least one rib is formed on at least either the hard portion of the accommodating portion or the lid portion.

A protector according to a fourth aspect is the protector according to any one of the first to third aspects, and the protector further includes a locking member formed separately from the accommodating portion and including a base member fixed to the hard portion of the accommodating portion and a locking portion provided on the base member and lockable to another member.

A protector according to a fifth aspect is the protector according to the fourth aspect, a pair of through holes communicating with the internal space of the accommodating portion are provided on the bottom portion of the accommodating portion along inner peripheral surfaces of base end parts of the pair of side walls of the accommodating portion, a pair of fixing portions are provided on parts of the base member of the locking member corresponding to the pair of side walls, and each of the pair of fixing portions (a) includes an outer piece standing along an outer peripheral surface of the corresponding one of the pair of side walls and an inner piece passing through the through hole on the corresponding side wall out of the pair of through holes and standing along an inner peripheral surface of the corresponding side wall and (b) fixes the corresponding side wall by sandwiching the corresponding side wall by the outer piece and the inner piece.

A protector according to a sixth aspect is the protector according to the fifth aspect, the locking member further includes a band portion having one end provided on the inner piece of one of the pair of fixing portions and a band fixing portion provided on the inner piece of the other of the pair of fixing portions and capable of fixing a tip side part of the band portion, and the band fixing portion is capable of fixing the tip side part of the band portion to hold the wiring harness in the internal space of the accommodating portion.

A wiring harness with protector according to a seventh aspect includes a protector according to any one of the first to sixth aspects and a wiring harness accommodated in the accommodating portion of the protector.

A wiring harness with protector according to an eighth aspect is the wiring harness with protector according to the seventh aspect, the protector includes a lid portion capable of closing the opening of the accommodating portion, the wiring harness with protector further includes a branched part exterior material formed separately from the accommodating portion and the lid portion and externally fitted on a branched part branched from the wiring harness accommodated in the accommodating portion, and a side portion on a tip side of the other side wall and a side portion on the other end side of the lid portion are placed one over the other with the branched part exterior material sandwiched between the side portion on the tip side of the other of the pair of side walls of the accommodating portion in the soft portion of the accommodating portion and the side portion on the other end side of the lid portion.

### Effects of the Invention

Also by the invention according to any one of the first to eighth aspects, the accommodating portion of the protector is formed of the sheet material obtained by partially pressing the flexible sheet-like nonwoven material containing the basic fibers and the binder having a lower melting point than the basic fibers from opposite sides and heating at least one surface of the pressed part, thereby having the cured partial area, and has the internal space capable of accommodating a wiring harness. The accommodating portion includes the hard portion and the soft portion softer than the hard portion along the longitudinal direction. This enables the protector to be brought to a manufacturing site for wiring harnesses and externally fitted on the wiring harness after being manufactured in advance. Thus, the wiring harness accommodated in the protector can be partially easily bent and deformed without introducing a hot-pressing machine for forming a shape capable of accommodating the wiring harness at the manufacturing site for wiring harnesses.

According to the invention relating to the second aspect, the lid portion is further provided which has the one end rotatably attached to the one of the pair of side walls of the accommodating portion of the protector and is capable of closing the opening of the accommodating portion. Thus, the opening of the accommodating portion can be closed with the lid portion after the wiring harness is accommodated into the accommodating portion without closing the lid portion, wherefore it is easy to externally fit the protector on the wiring harness and protect the wiring harness over the entire circumference.

According to the invention relating to the third aspect, at least one rib is formed on at least either the hard portion of the accommodating portion or the lid portion. Since this can enhance the rigidity of the accommodating portion even if the sheet material is thinned, the protector can be reduced in weight.

According to the invention relating to the fourth aspect, the protector further includes the locking member formed separately from the accommodating portion and including the base member fixed to the hard portion of the accommodating portion and the locking portion provided on the base member and lockable to another member. Since the locking portion of the locking member can be locked to the other member, the protector can be easily fixed to the other member. Further, since the locking member is attached to the hard portion of the protector, it can be more firmly fixed to the protector.

According to the invention relating to the fifth aspect, the pair of through holes communicating with the internal space of the accommodating portion are provided on the bottom portion of the accommodating portion along the inner peripheral surfaces of the base end parts of the pair of side walls of the accommodating portion, the pair of fixing portions are provided on the parts of the base member of the locking member corresponding to the pair of side walls, and each of the pair of fixing portions (a) includes the outer piece standing along the outer peripheral surface of the corresponding one of the pair of side walls and the inner piece passing through the through hole on the corresponding side wall out of the pair of through holes and standing along the inner peripheral surface of the corresponding side wall and (b) fixes the corresponding side wall by sandwiching the corresponding side wall by the outer piece and the inner piece. Thus, the shape of the protector provided with the internal space capable of accommodating the wiring harness is more easily maintained. Further, the locking member can be easily fixed to the protector.

According to the invention relating to the sixth aspect, the locking member further includes the band portion having the one end provided on the inner piece of one of the pair of fixing portions and the band fixing portion provided on the inner piece of the other of the pair of fixing portions and capable of fixing the tip side part of the band portion. The band fixing portion is capable of fixing the tip side part of the band portion to hold the wiring harness in the internal space of the accommodating portion. In this way, the wiring harness is accommodated in the accommodating portion while having such a cross-sectional shape as to be held in the internal space of the accommodating portion.

According to the invention relating to the eighth aspect, the wiring harness with protector further includes the branched part exterior material formed separately from the accommodating portion and the lid portion and externally fitted on the branched part branched from the wiring harness accommodated in the accommodating portion. The side portion on the tip side of the other side wall and the side portion on the other end side of the lid portion are placed one over the other with the branched part exterior material sandwiched between the side portion on the tip side of the other of the pair of side walls of the accommodating portion in the soft portion of the accommodating portion and the side portion on the other end side of the lid portion. Thus, the branched part exterior material can be fixed to the integrally formed protector by fixing the side portion on the tip side of the other side wall of the accommodating portion and the side portion on the other end side of the lid portion to each other, wherefore the branched part is easily protected. Further, the branched position of the branched part is easily maintained.

### BRIEF DESCRIPTION OF THE DRAWINGS

FIG. 1 is a perspective view showing an example of a protector according to an embodiment,

FIG. 2 is a section of the protector of FIG. 1 cut at a hard portion,

FIG. 3 is a perspective view showing another example of the protector according to the embodiment,

FIG. 4 is a perspective view showing the protector of FIG. 3 with a wiring harness accommodated therein,

FIG. 5 is a perspective view showing a state where a lid portion of the protector of FIG. 4 is closed,

FIG. 6 is a perspective view showing a state where a branched part exterior material is attached to the protector of FIG. 4,

FIG. 7 is a perspective view showing a state where the lid portion of the protector of FIG. 6 is closed,

FIG. 8 is a perspective view showing an example of a sheet material according to the embodiment formed with ribs,

FIG. 9 is a perspective view showing an example of a locking member to be attached to the protector according to the embodiment,

FIG. 10 is a perspective view showing the protector according to the embodiment with the locking member of FIG. 9 attached thereto,

FIG. 11 is a section along A1-A1 of the protector of FIG. 10,

FIG. 12 is a perspective view showing another example of the locking member to be attached to the protector according to the embodiment,

FIG. 13 is a perspective view showing the protector according to the embodiment with the locking member of FIG. 12 attached thereto,

FIG. 14 is a perspective view showing an example of a manufacturing apparatus for manufacturing a protector according to the embodiment, and

FIG. 15 is a section showing a state where the manufacturing apparatus of FIG. 14 is processing a nonwoven sheet material.

### EMBODIMENT OF THE INVENTION

Hereinafter, an embodiment of the present invention is described with reference to the drawings. Parts having similar configurations and functions are denoted by the same reference signs in the drawings and not repeatedly described in the following description.

### Embodiment

A protector according to the embodiment is formed of a sheet material formed such that a processed state is at least partially different by heating and compressing (“thermocompression”) at least a part of a sheet-like nonwoven material (also called a “nonwoven sheet material”) processable to have a high rigidity by being compressed in a high-temperature state.

The nonwoven sheet material used in the manufacturing of the protector according to the embodiment is a sheet-like fiber material in which a plurality of fibers are entangled without being woven and is flexible. This nonwoven sheet material can be processed to exhibit a high rigidity by being at least partially melted by heating and, further, cured.

Specifically, a flexible material containing basic fibers to be entangled and adhesive resin (also called “binder”) can be used as the nonwoven sheet material. The adhesive resin is resin having a lower melting point than the basic fibers. The adhesive resin is melted and infiltrates between the basic fibers by heating this nonwoven sheet material at a temperature lower than the melting point of the basic fibers and higher than the melting point of the adhesive resin. Thereafter, when the nonwoven sheet material reaches a temperature lower than the melting point of the adhesive resin, the adhesive resin is solidified with the basic fibers bonded. In this way, the nonwoven material is cured and becomes harder than in a state before heating. Further, if the nonwoven sheet material is compressed in the state where the adhesive resin is melted, this nonwoven sheet material is maintained in a predetermined molded shape during that compression.

The adhesive resin may be granulated or fibrous. Binder fibers may be configured by forming adhesive resin layers on the outer peripheries of core fibers and these may be entangled with the basic fibers. Core fibers made of the same material as the basic fibers can be used as the core fibers in this case.

The basic fibers have only to be able to maintain a fibrous state at the melting point of the adhesive resin and various fibers can be used besides resin fibers. Further, thermoplastic resin fibers having a melting point lower than that of the basic fibers can be used as the adhesive resin. A combination of PET (polyethylene terephthalate) resin fibers as the basic fibers and copolymer resin of PET and PEI (polyethylene isophthalate) as the adhesive resin is an example of a combination of the basic fibers and the adhesive resin. In this case, the melting point of the basic fibers is higher than that of the adhesive resin. Thus, if a nonwoven material is heated to a temperature between the melting point of the basic fibers and that of the adhesive resin, the adhesive resin is melted and infiltrates between the basic fibers kept in the fibrous state without being melted. When the nonwoven material reaches a temperature lower than the melting point of the adhesive resin, the adhesive resin is solidified with the basic fibers bonded to each other and the nonwoven material becomes hard to maintain a molded shape during heating. That is, by sandwiching the above nonwoven sheet material between predetermined surfaces and compressing it in a high-temperature state, the nonwoven sheet material is molded into a predetermined shape corresponding to the shapes of the predetermined surfaces and maintained in the molded shape when being cooled.

More specifically, the protector according to the embodiment includes an accommodating portion formed of a sheet material obtained by partially pressing the nonwoven sheet material from opposite sides and heating at least one surface of a pressed part, thereby having a cured partial area, and having an internal space capable of accommodating a wiring harness. The accommodating portion includes a hard portion and a soft portion softer than the hard portion along a longitudinal direction. The hard portion is a part of the nonwoven sheet material cured by thermocompression. Further, the wiring harness accommodated in the protector according to the embodiment is a wiring harness with protector according to the embodiment.

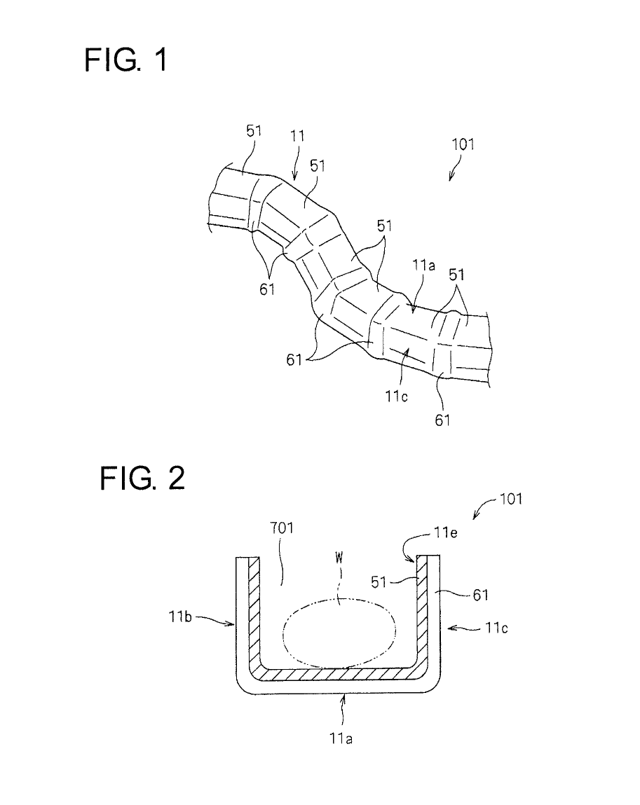

A protector 101 is an example of the protector according to the embodiment and alternately includes hard portions 51 and soft portions 61 in a longitudinal direction (see FIGS. 1 and 2). Further, the protector 101 includes an accommodating portion 11 with an internal space 701 capable of accommodating a wiring harness W. The accommodating portion 11 is formed into a gutter shape including a bottom portion 11a and a pair of side walls 11b, 11c projecting toward the same side from opposite sides of the bottom portion 11a. The protector 101 is highly bendable in each of a plurality of soft portions 61. Thus, even the wiring harness W to be routed along a routing path bent in a complicated manner can be accommodated along this routing path. Further, by using two protectors 101, two protectors 101 form one tubular body, for example, if the side walls are so placed one over the other that openings 11e of the respective protectors 101 face each other in a state where the wiring harness W is arranged in one protector 101. By being fixed such as by tape winding in this state, the protectors 101 can be used as a protector excellent in bendability and capable of protecting the wiring harness W over the entire circumference.

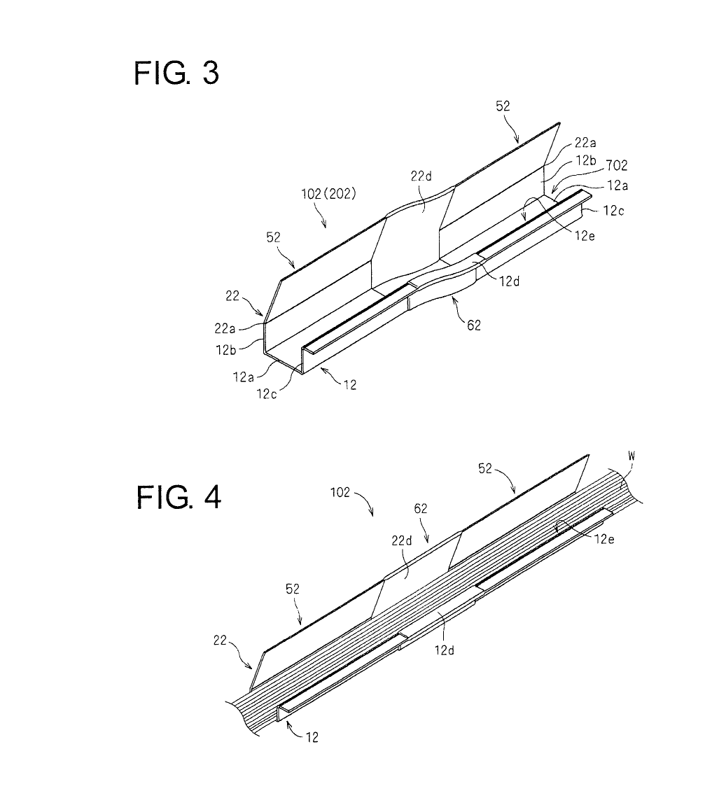

A protector 102 is an example of the protector according to the embodiment and includes an accommodating portion 12 with an internal space 702 capable of accommodating a wiring harness (see FIG. 3). Specifically, the accommodating portion 12 is formed into a gutter shape including a bottom portion 12a and a pair of side walls 12b, 12c projecting toward the same side from opposite sides of the bottom portion 12a. Further, the accommodating portion 12 includes a flange portion (“side portion”) 12d formed by bending a tip part of the side wall 12c outwardly of the accommodating portion 12.

The protector 102 also includes a lid portion 22 capable of closing an opening 12e. One end of the lid portion 22 is provided rotatably at least toward the flange portion 12d by a hinge portion 22a. The hinge portion 22a is, for example, formed by thermocompressing only one surface side of the nonwoven sheet material. By rotating the lid portion 22 about the hinge portion 22a and bringing a side portion 22a on the other end side of the lid portion 22 into contact with the flange portion 12d, the opening 12e is closed. Since a contact area of the side wall 12c and the lid portion 22 increases by providing the flange portion 12d, the opening 12e is easily closed.

Further, opposite longitudinal end parts of the protector 102 are formed by hard portions 52 cured by thermocompressing the nonwoven sheet material, and a longitudinal central part is formed by a soft portion 62 softer than the hard portions 52. Specifically, the protector 102 alternately includes the hard portions 52 and the soft portion 62 along a longitudinal direction. The soft portion 62 is softer than the hard portions 52 and more easily deformed than the hard portions 52. Thus, even if a routing path for a wiring harness is bent, a bent part can be easily protected if the protector 102 is so externally fitted on the wiring harness that the soft portion 62 of the protector 102 extends along the bent part of the wiring harness. As just described, the soft portion 62 of the protector 102 is also a soft portion for bending deformation.

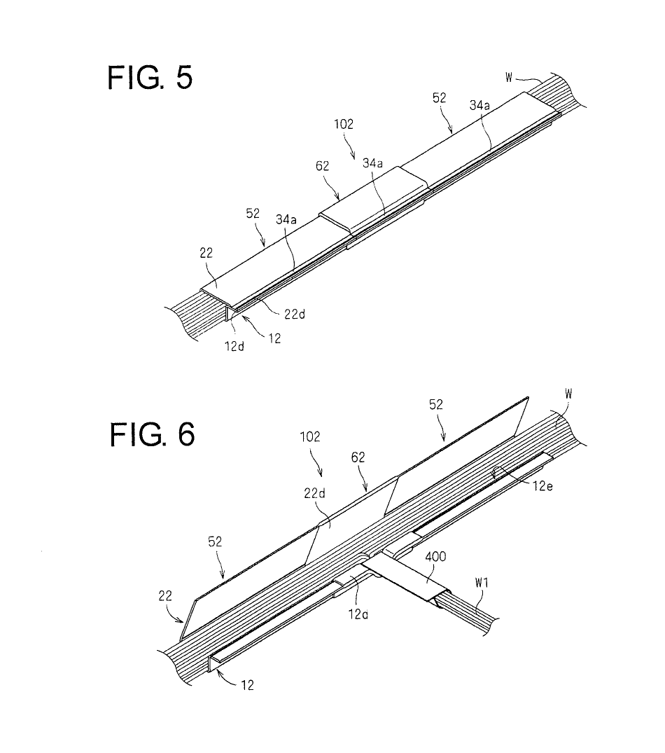

Further, the wiring harness W is routed and accommodated along the longitudinal direction of the protector 102 in an accommodation space of the accommodating portion 12 of the protector 102 (see FIG. 4). Then, the side portion 22d and the flange portion 12d are fixed by being adhered to each other at an adhering portion 34a in a state where the lid portion 22 closes the opening 12e of the accommodating portion 12 and the side portion 22d on the other end side of the lid portion 22 and the flange portion 12d are placed one over the other (see FIG. 5). Note that, in FIGS. 4 and 5, the soft portion 62 of the protector 102 is not bent and shown to linearly extend along a longitudinal direction of the accommodation space in the hard portions 52. Further, the protector 102 and the wiring harness W constitute a wiring harness with protector.

At the adhering portion 34a, the side portion 22d and the flange portion 12d are welded by heat welding for pressing by a heating element or by ultrasonic welding. Instead of fixation by welding, fixing means such as fixation by a two-sided adhesive tape or stapling may be adopted. Further, there may be adopted a technique of fixing the lid portion 22 and the flange portion 12d by winding an adhesive tape around the protector 102 along a circumferential direction of the protector 102 with the opening 12e closed by the lid portion 22. If the side portion 22d on the other end side of the lid portion 22 and the flange portion 12d of the other side wall 12c of the accommodating portion 12 are fixed to each other while being placed one over the other in this way, it can be suppressed that the lid portion 22 is pressed by the wiring harness accommodated in the protector 102 to be released.

The protector 102 may have a surface formed with at least one rib (a plurality of ribs 181 in a lattice-like arrangement are shown), for example, as in a part 206 shown in FIG. 8. The at least one rib is formed, for example, on at least either the hard portions 52 of the accommodating portion 12 or the lid portion 22. If the rib(s) is/are formed, the rigidity of the accommodating portion can be enhanced even if a sheet material 202 constituting the protector 102 is thinned. Thus, the protector 102 can be reduced in weight.

Further, FIG. 6 shows a state where a branched part W1 of the wiring harness W accommodated in the protector 102 shown in FIG. 4 is drawn out from the protector 102 at the flange portion 12d in the soft portion 62. More specifically, a branched part exterior material 400 is externally fitted on the branched part W1 and attached to the flange portion 12d. The branched part exterior material 400 is formed by winding a nonwoven sheet material around the branched part W1 and welding end parts to each other or by fixing the nonwoven sheet material by a two-sided adhesive tape. The side portion 22d of the lid portion 22 is placed on the flange portion 12d of the accommodating portion 12 with the branched part exterior material 400 attached to the flange portion 12d.

In this state, the flange portion 12d of the accommodating portion 12 and the side portion 22d of the lid portion 22 are placed one over the other with the branched part exterior material 400 sandwiched between the flange portion 12d and the side portion 22d. Thus, the branched part exterior material 400 can be fixed to the integrally formed protector 102 by fixing the flange portion 12d on the tip side of the other side wall 12c of the accommodating portion 12 and the side portion 22d on the other end side of the lid portion 22 to each other. In this way, the branched part W1 is easily protected.

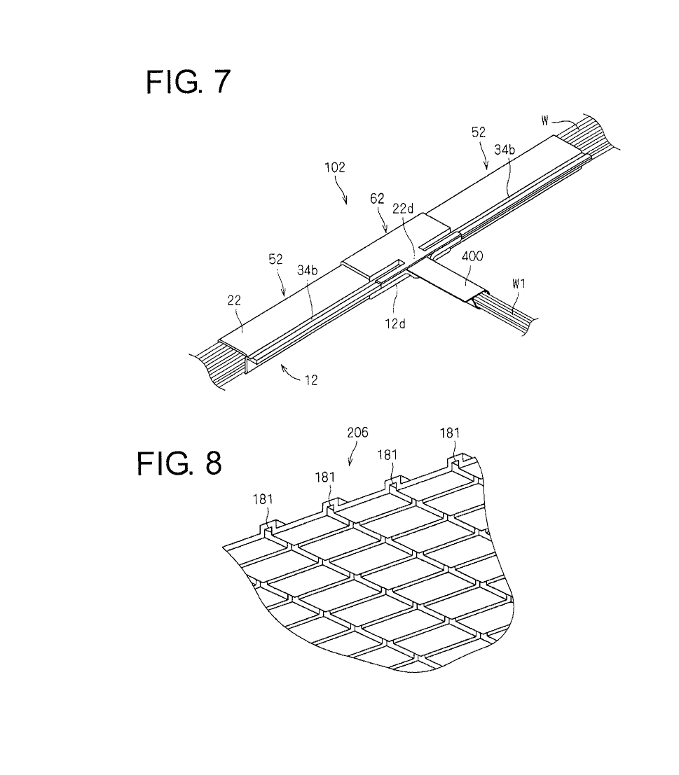

By fixing the side portion 22d of the lid portion 22 and the flange portion 12d of the accommodating portion 12 to each other with the branched part exterior material 400 sandwiched between the flange portion 12d and the side portion 22d and with the flange portion 12d and the side portion 22d placed one over the other, the branched part exterior material 400 is also fixed to the protector 102 during this fixing (see FIG. 7). The accommodating portion 12 includes the hard portions 52 cured by thermocompressing the nonwoven sheet material and the soft portion 62 softer than the hard portions 52. At least either one of parts of the side portion 22d of the lid portion 22 and the flange portion 12d of the accommodating portion 12 sandwiching the branched part exterior material 400 is preferably formed by the soft portion 62.

In this case, the part formed by the soft portion 62 out of the parts of the side portion 22d of the lid portion 22 and the flange portion 12d sandwiching the branched part exterior material 400 is recessed according to a cross-sectional shape of the branched part exterior material 400. Since this enables the branched part exterior material 400 to be held in closer contact with the side portion 22d of the lid portion 22 and the flange portion 12d of the accommodating portion 12, the branched part exterior material 400 can be more reliably held by the protector 102. Further, since a recess is formed on the soft portion 62 when the branched part exterior material 400 is attached to the soft portion 62 and the lid portion 22 is closed, the branched position of the branched part W1 is easily maintained. Note that even if the branched part exterior material 400 is attached by being sandwiched between the hard portions 52 of the lid portion 22 and the flange portion 12d, the utility of the present invention is not impaired.

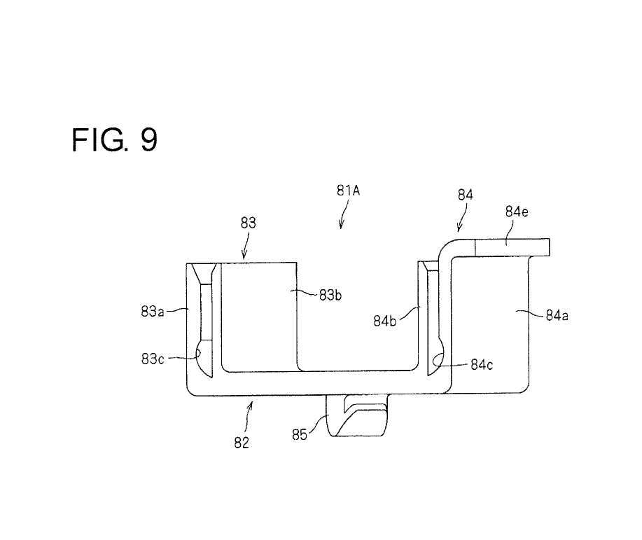

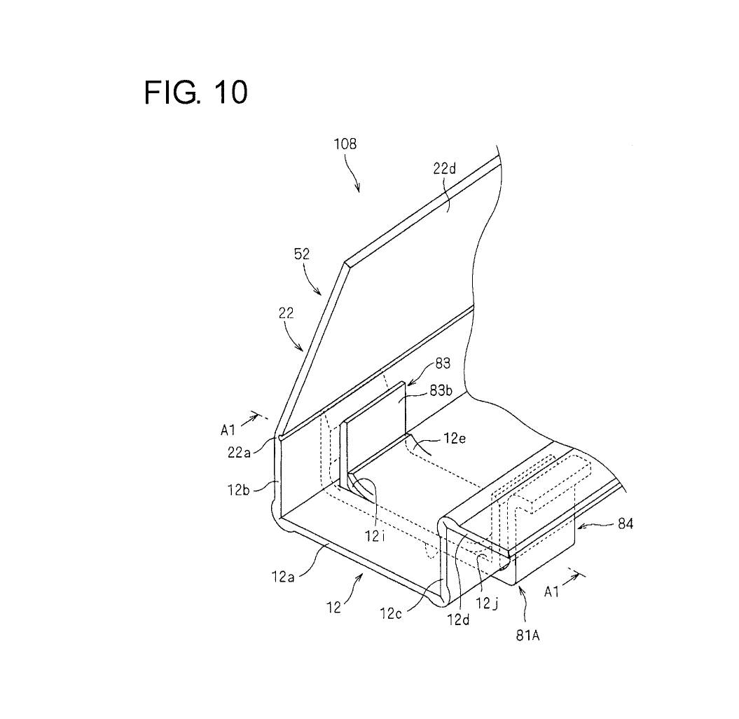

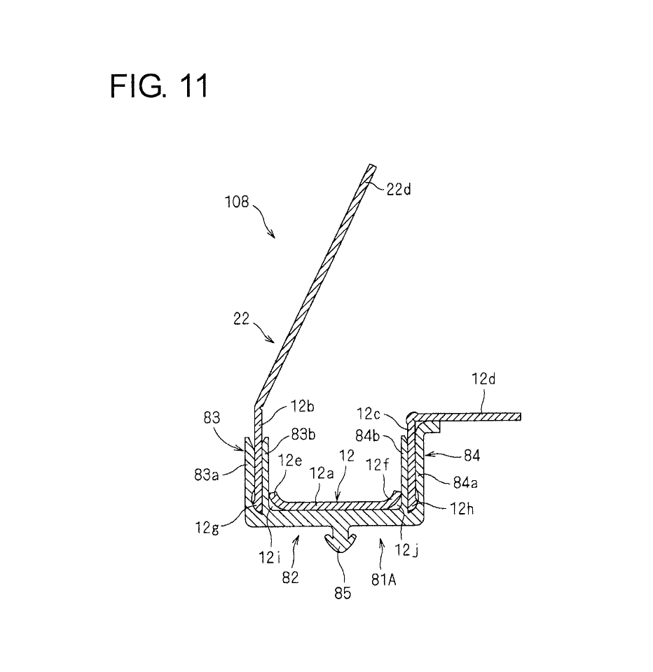

A locking member 81A is an example of a locking member capable of fixing the protector to another member such as a vehicle body panel by being attached to the protector according to the embodiment, and attached to the outer peripheral surface of a protector 108 according to the embodiment (see FIGS. 9 to 11).

The locking member 81A includes a base member 82 in the form of a rectangular plate fixed to the outer peripheral surface of an accommodating portion 12 of the protector 108 and a locking portion 85 provided on the base member 82 and having a locking claw lockable to another member such as a vehicle body panel, and is formed separately from the accommodating portion 12 of the protector 108. Since including the locking member 81A attached to the accommodating portion 12, the protector 108 can be easily fixed to another member. Further, the strength of the protector 108 can be reinforced by the locking member 81A.

The protector 108 is formed to include the gutter-like accommodating portion 12 with a bottom portion 12a and a pair of side walls 12b, 12c projecting toward the same side from opposite sides of the bottom portion 12a. Further, a lid portion 22 is connected to a tip part of one side wall 12b via a hinge portion 22a. A pair of through holes 12i, 12j communicating with an internal space of the accommodating portion 12 are provided on the bottom portion 12a of the protector 108 along the inner peripheral surfaces of base end parts of the pair of side walls 12b, 12c of the accommodating portion 12.

One through hole 12i is formed by a cut provided along the inner peripheral surface of the base end part of the side wall 12b in a part of the bottom portion 12a on the side of the one side wall 12b. The other through hole 12j is formed by a cut provided along the inner peripheral surface of the base end part of the side wall 12c in a part of the bottom portion 12a on the side of the other side wall 12c.

As described later, inner pieces 83b, 84b of a pair of fixing portions 83, 84 projecting from the base member 82 of the locking member 81A toward the protector 108 are respectively inserted into the pair of through holes 12i, 12j. To facilitate this insertion, a pair of cuts are formed to extend from opposite sides of the through hole 12i toward a central side of the bottom portion 12a along a direction crossing the inner peripheral surface of the base end part of the side wall 12b, and a pair of cuts are formed to extend from opposite sides of the through hole 12j toward the central side of the bottom portion 12a along a direction crossing the inner peripheral surface of the base end part of the side wall 12c.

In this way, even if widths of the pair of through holes 12i, 12j are smaller than thicknesses of the inner pieces 83b, 84b, turn-up portions 12e, 12f of the bottom portion 12a are turned up and curved toward the accommodation space of the accommodating portion 12 as the inner pieces 83b, 84b are inserted into the through holes 12i, 12j, whereby the insertion of the inner pieces 83b, 84b into the pair of through holes 12i, 12j is facilitated. The turn-up portion 12e is a part surrounded by the through hole 12i and the pair of cuts formed to extend from the opposite sides of the through hole 12i out of the bottom portion 12a, and the turn-up portion 12f is a part surrounded by the through hole 12j and the pair of cuts formed to extend from the opposite sides of the through hole 12j. Thus, if the widths of the through holes 12i, 12j are substantially equal to the thicknesses of the inner pieces 83b, 84b, the pair of cuts formed to extend from the opposite sides of each of the through holes 12i, 12j are not necessary.

Further, parts of the side walls 12b, 12c of the protector 108 facing the through holes 12i, 12j are formed with bulging portions 12g, 12h. The bulging portions 12g, 12h are locked to recesses 83c, 84c formed on bottom parts of the pair of fixing portions 83, 84 of the locking member 81A when the locking member 81A is attached to the protector 108. The protector 108 is configured similarly to the protector 102 except for including the pair of through holes 12i, 12j, the pair of cuts formed to extend from the opposite sides of the pair of through holes 12i, 12j and the bulging portions 12g, 12h of the side walls 12b, 12c. Further, the locking member 81A is normally attached to the hard portions 52, out of the hard portions 52 and the soft portion 62, to be easily fixed to the protector 108.

More specifically, the pair of fixing portions 83, 84 are provided on parts of the base member 82 of the locking member 81A corresponding to the pair of side walls 12b, 12c of the protector 108. Out of the fixing portions 83, 84, the fixing portion 83 includes an outer piece 83a standing along the outer peripheral surface of the corresponding one 12b of the pair of side walls 12b, 12c and the inner piece 83b passing through the through hole 12i on the corresponding side wall 12b out of the pair of through holes 12i, 12j and standing along the inner peripheral surface of the side wall 12b.

Out of the fixing portions 83, 84, the fixing portion 84 includes an outer piece 84a standing along the outer peripheral surface of the corresponding one 12c of the pair of side walls 12b, 12c and the inner piece 84b passing through the through hole 12j on the corresponding side wall 12c out of the pair of through holes 12i, 12j and standing along the inner peripheral surface of the side wall 12c. The fixing portion 83 and the side wall 12b are fixed to each other by sandwiching the side wall 12b by the outer piece 83a and the inner piece 83b of the fixing portion 83 and locking the bulging portion 12g of the side wall 12b to the recess 83c forming the bottom part of the fixing portion 83. Further, the fixing portion 84 and the side wall 12c are fixed to each other by sandwiching the side wall 12c by the outer piece 84a and the inner piece 84b of the fixing portion 84 and locking the bulging portion 12h of the side wall 12c to the recess 84c forming the bottom part of the fixing portion 84.

Accordingly, the tilt of the pair of side walls 12b, 12c of the accommodating portion 12 is regulated by the outer pieces 83a, 84a and the inner pieces 83b, 84b of the pair of fixing portions 83, 84 of the locking member 81A with the locking member 81A attached to the protector 108. In this way, the shape (cross-sectional shape) of the assembled accommodating portion 12 is easily maintained. Further, the locking member 81A can be easily attached to the protector 108.

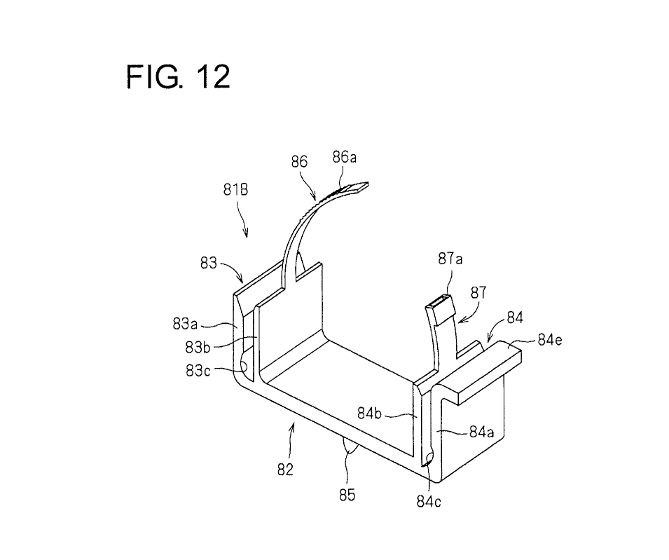

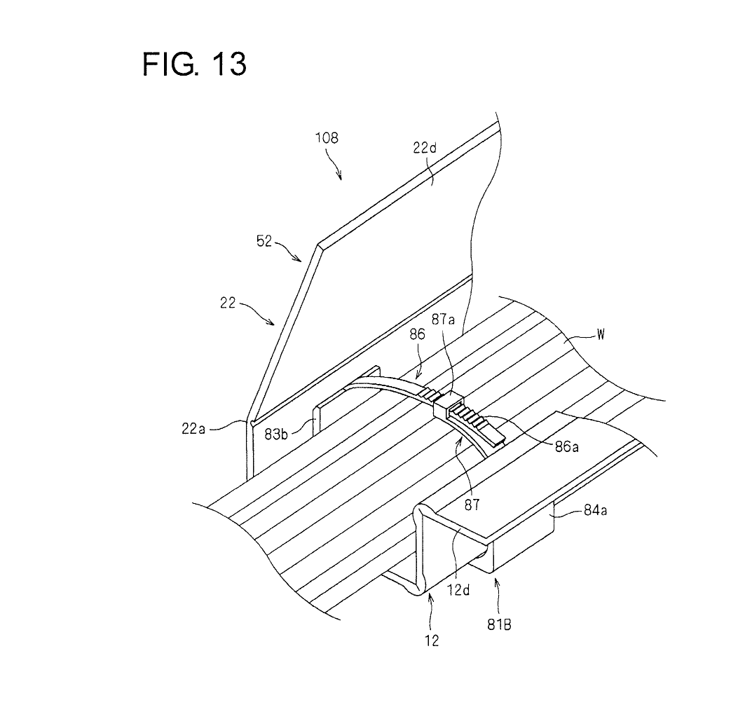

A locking member 81B is another example of the locking member attached to the protector 108 according to the embodiment (see FIGS. 12 and 13). The locking member 81B is configured similarly to the locking member 81A except for including a band portion 86 and a band fixing portion 87.

One end of the band portion 86 is provided on an inner piece 83b of one 83 of a pair of fixing portions 83, 84. The band fixing portion 87 is provided on an inner piece 84b of the other 84 of the pair of fixing portions 83, 84 and a frame portion 87a, to which a tip side part of the band portion 86 can be fixed, is formed on a tip part. The band portion 86 is formed with a plurality of projections 86 on a tip side part thereof. One of the projections 86a is locked to a claw portion provided on the inner peripheral surface of the frame portion 87a with the tip side part of the band portion 86 inserted in the band fixing portion 87. In this way, the band fixing portion 87 can fix the tip side part of the band portion 86 to hold the wiring harness W accommodated in the protector 108 in the internal space of the accommodating portion 12.

Accordingly, the wiring harness W is accommodated in the accommodating portion 12 while having such a cross-sectional shape as to be held in the internal space of the accommodating portion 12. Thus, the cross-sectional shape of the wiring harness is maintained to be a flat shape when the wiring harness W is accommodated into the protector 108 provided with the locking member 81B and fixed by the band portion 86 and the band fixing portion 87 of the locking member 81B in the case where a height of the accommodating portion 12 is shorter than a cross-sectional diameter of the wiring harness W having a circular cross-section. Thus, if the protector 108 provided with the locking member 81B is used, the wiring harness routed along a routing path having a flat cross-section is easily protected. Further, the wiring harness can be easily fixed to another member such as a vehicle body panel via the protector 108.

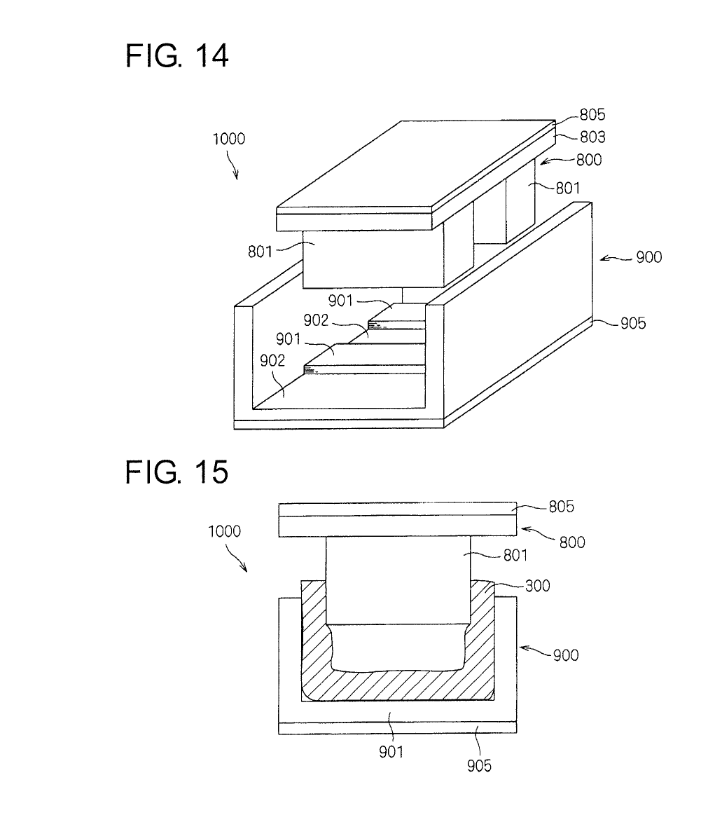

A manufacturing apparatus 1000 is an example of a manufacturing apparatus for manufacturing a protector according to the embodiment (see FIG. 14). The manufacturing apparatus 1000 is mainly composed of an upper mold 800 and a lower mold 900 respectively formed of metal, a heater 805 and a heater 905.

The upper mold 800 includes a base portion 803 in the form of a flat plate and two blocks 801 provided on the lower surface of the base portion 803. The heater 805 is provided in contact with the upper surface of the base portion 803 and heats the entire upper mold 800 including each block 801.

The lower mold 900 is in the form of a gutter obtained by integrally forming a bottom portion and a pair of side walls standing from opposite sides of the bottom portion. Convex portions 901 and concave portions 902 recessed relative to the convex portions 901 are alternately provided on the upper surface of the bottom portion. The accommodation space heater 905 of the lower mold 900 is provided in contact with the lower surface of the bottom portion of the lower mold 900 and heats the entire lower mold 900.

Widths of the blocks 801 of the upper mold 800 are slightly smaller than that of an accommodation space of the lower mold 900. Further, the blocks 801 of the upper mold 800 and the convex portions 901 of the lower mold 900 are facing each other. This causes a nonwoven sheet material 300 to be hot-pressed by pressing down the upper mold 800 into the accommodation space of the lower mold 900 with the nonwoven sheet material 300 placed in the accommodation space of the lower mold 900 (see FIG. 15). Note that the upper mold 800 and the lower mold 900 are heated to a temperature between melting points of basic fibers and adhesive resin of the nonwoven sheet material 300 by the heaters 805, 905. Parts hot-pressed by the blocks 801 and the convex portions 901 are cured to become hard portions and other parts become soft portions softer than the hard portions and substantially keeping the flexibility of the nonwoven sheet material 300.

By processing the nonwoven sheet material 300 by the manufacturing apparatus 1000, a gutter-like protector alternately including the hard portions and the soft portions along a longitudinal direction (routing direction of the wiring harness) is molded. In this case, for example, corner parts between the bottom portion and the side walls of the accommodating portion and the like are plastically deformed and creased. Thus, a cross-sectional shape of the accommodating portion of the protector is maintained also after the protector is removed from the manufacturing apparatus 1000. Note that, if a lid portion is necessary, the lid portion can be formed by performing processing by the manufacturing apparatus 1000 with one widthwise end of the nonwoven sheet material 300 protruding from the accommodation space of the lower mold 900 and subsequently hot-pressing the protruding part by a mold in the form of a flat plate. Further, in the case of forming a rib, hot-pressing may be performed using a mold provided with convex and concave portions. Further, a fold can be formed on the sheet material such as by cutting the processed sheet material up to an intermediate position in a thickness direction in such a manner as not to completely cut the sheet material or by heating only one surface of the nonwoven sheet material during heating and compression and causing only a part in the thickness direction to be cured. If a fold is provided on the sheet material and the sheet material is folded along the fold, the sheet material is more easily folded than in the case where the sheet material is folded in a part where no fold is formed. The number of folds formed on the sheet material may be one or more.

The lid portion, the fold and the rib(s) may be molded after the gutter-like accommodating portion is molded or may be molded simultaneously with the accommodating portion such as by forming the blocks of the manufacturing apparatus 1000 as inserts. Further, the protector according to the embodiment needs not necessarily be molded to have the shape of the accommodating portion by being hot-pressed. For example, a sheet material obtained by partially pressing a nonwoven sheet material (sheet-like nonwoven material) from opposite sides and heating at least one surface of the pressed part, thereby having a cured partial area may be first produced and, thereafter, a protector provided with an accommodating portion capable of accommodating a wiring harness may be manufactured by folding or rolling this sheet material.

According to the protector 101 and the wiring harness with protector relating to this embodiment as described above, the accommodating portion 11 is formed of the sheet material obtained by partially pressing the flexible nonwoven sheet material (sheet-like nonwoven material) containing the basic fibers and the adhesive resin (binder) having a lower melting point from opposite sides and heating at least one surface of the pressed part, thereby having the cured partial area, and has the internal space 701 capable of accommodating the wiring harness W. The accommodating portion 11 includes the hard portions 51 and the soft portions 61 softer than the hard portions 51 along the longitudinal direction. This enables the protector 101 to be brought to a manufacturing site for wiring harnesses and externally fitted on the wiring harness after being manufactured in advance. Thus, the wiring harness W accommodated in the protector 101 can be partially easily bent and deformed without introducing a hot-pressing machine for forming a shape capable of accommodating the wiring harness at the manufacturing site for wiring harnesses.

Further, according to the protector 102 relating to this embodiment as described above, the lid portion 22 is further provided which has one end rotatably attached to the one 12b of the pair of side walls 12b, 12c of the accommodating portion 12 and is capable of closing the opening 12e of the accommodating portion 12. Thus, the opening 12e of the accommodating portion 12 can be closed with the lid portion 22 after the wiring harness is accommodated into the accommodating portion 12 without closing the lid portion 22, wherefore it is easy to externally fit the protector 102 on the wiring harness and protect the wiring harness over the entire circumference.

Further, according to the protector 102 relating to this embodiment as described above, at least one rib 181 is formed on at least either the hard portions 52 of the accommodating portion 12 or the lid portion 22. Since this can enhance the rigidity of the accommodating portion 12 even if the sheet material forming the protector 102 is thinned, the protector 102 can be reduced in weight.

Further, the protector 108 relating to this embodiment as described above further includes the locking member 81A formed separately from the accommodating portion 12 and including the base member 82 fixed to the outer peripheral surface of the accommodating portion 12 and the locking portion 85 provided on the base member 82 and lockable to another member. Since the locking portion 85 of the locking member 81A can be locked to the other member, the protector 108 can be easily fixed to the other member. Further, the protector can be reinforced by the locking member 81A.

Further, according to the protector 108 relating to this embodiment as described above, the accommodating portion 12 is formed into a gutter shape including the bottom portion 12a and the pair of side walls 12b, 12c, and the pair of through holes 12i, 12j communicating with the internal space of the accommodating portion 12 are provided on the bottom portion 12a of the accommodating portion 12 along the inner peripheral surfaces of the base end parts of the pair of side walls 12b, 12c of the accommodating portion 12. Further, the pair of fixing portions 83, 84 are provided on the parts of the base member 82 corresponding to the pair of side walls 12b, 12c. The fixing portion 83 (84) includes the outer piece 83a (84a) standing along the outer peripheral surface of the corresponding one 12b (12c) of the pair of side walls 12b, 12c and the inner piece 83b (84b) passing through the through hole 12i (12j) on the corresponding side wall 12b (12c) out of the pair of through holes 12i, 12j and standing along the inner peripheral surface of the corresponding side wall 12b (12c), and the outer piece 83a (84a) and the inner piece 83b (84b) fix the corresponding side wall 12b (12c) by sandwiching the side wall 12b (12c). Thus, the tilt of the side wall 12b (12c) of the accommodating portion 12 is regulated by the outer piece 83a (84a) and the inner piece 83b (84b) of the fixing portion 83 (84), whereby the shape of the accommodating portion 12 is easily maintained. Further, the locking member 81A can be easily fixed to the protector 108.

Further, according to the protector 108 relating to this embodiment as described above, the locking member 81B further includes the band portion 86 having the one end provided on the inner piece 83b of the one 83 of the pair of fixing portions 83, 84 and the band fixing portion 87 provided on the inner piece 84b of the other 84 of the pair of fixing portions 83, 84 and capable of fixing the tip side part of the band portion 86. The band fixing portion 87 can fix the tip side part of the band portion 86 to hold the wiring harness W in the internal space of the accommodating portion 12. In this way, the wiring harness W is accommodated in the accommodating portion 12 while having such a cross-sectional shape as to be held in the internal space of the accommodating portion 12.

Further, the wiring harness with protector relating to this embodiment as described above further includes the branched part exterior material 400 formed separately from the accommodating portion 12 and the lid portion 22 and externally fitted on the branched part W1 branched from the wiring harness W accommodated in the accommodating portion 12. With the branched part exterior material 400 sandwiched between the side portion (flange portion) 12d on the tip side of the other 12c of the pair of side walls 12b, 12c of the accommodating portion 12 in the soft portion 62 of the accommodating portion 12 and the side portion 22d on the other end side of the lid portion 22, the side portion 12d on the tip side of the other side wall 12c and the side portion 22d on the other end side of the lid portion 22 can be placed one over the other. Thus, the branched part exterior material 400 can be fixed to the integrally formed protector 102 by fixing the side portion 22d on the tip side of the other side wall 12c of the accommodating portion 12 and the side portion 22d on the other end side of the lid portion 22 to each other, wherefore the branched part W1 is easily protected. Further, the branched position of the branched part W1 is easily maintained.

Although this invention has been described in detail above, the above description is illustrative in all aspects and this invention is not limited thereby. It should be understood that unillustrated numerous modifications can be made without departing from the scope of this invention.

### LIST OF REFERENCE SIGNS

101, 102 protector
11, 12 accommodating portion
11a, 12a bottom portion
11b, 11c, 12b, 12c side wall
12d flange portion (side portion)
11e, 12e opening
181 rib
202 sheet material
lid portion
22d side portion
300 nonwoven sheet material (sheet-like nonwoven material)
400 branched part exterior material
52, 53 hard portion
soft portion
81A, 81B locking member
101, 102 protector
51, 52 hard portion
61, 62 soft portion
1000 manufacturing apparatus
800 upper mold
801 block
900 lower mold
901 convex portion
902 concave portion
805, 905 heater
W wiring harness
W1 branched part

1. A protector, comprising an accommodating portion formed of a sheet material obtained by partially pressing a flexible sheet-like nonwoven material containing basic fibers and a binder having a lower melting point than the basic fibers from opposite sides and heating at least one surface of a pressed part, thereby having a cured partial area, and having an internal space configured to accommodate a wiring harness, wherein:
the accommodating portion includes a hard portion and a soft portion softer than the hard portion extending along a longitudinal direction.

2. A protector according to claim 1, wherein:
the accommodating portion is formed into a gutter shape including a bottom portion and a pair of side walls projecting toward the same side from opposite sides of the bottom portion; and
the protector further comprises a lid portion having one end rotatably provided on one of the pair of side walls of the accommodating portion and configured to close an opening of the accommodating portion.

3. A protector according to claim 2, wherein at least one rib is formed on at least either the hard portion of the accommodating portion or the lid portion.

4. A protector according to claim 2, further comprising a locking member formed separately from the accommodating portion and including a base member fixed to the hard portion of the accommodating portion and a locking portion provided on the base member and lockable to another member.

5. A protector according to claim 4, wherein:
a pair of through holes communicating with the internal space of the accommodating portion are provided on the bottom portion of the accommodating portion along inner peripheral surfaces of base end parts of the pair of side walls of the accommodating portion;
a pair of fixing portions are provided on parts of the base member of the locking member corresponding to the pair of side walls; and
each of the pair of fixing portions includes an outer piece standing along an outer peripheral surface of the corresponding one of the pair of side walls and an inner piece passing through the through hole on the corresponding side wall out of the pair of through holes and standing along an inner peripheral surface of the corresponding side wall; and fixes the corresponding side wall by sandwiching the corresponding side wall by the outer piece and the inner piece.

6. A protector according to claim 5, wherein:
the locking member further includes:
a band portion having one end provided on the inner piece of one of the pair of fixing portions; and
a band fixing portion provided on the inner piece of the other of the pair of fixing portions and configured to fix the tip side part of the band portion to hold the wiring harness in the internal space of the accommodating portion.

7. A wiring harness with protector, comprising:
a protector according to claim 1; and
a wiring harness accommodated in the accommodating portion of the protector.

8. A wiring harness with protector according to claim 7, wherein:
the protector includes a lid portion configured to close an opening of the accommodating portion;
the wiring harness with protector further comprises a branched part exterior material formed separately from the accommodating portion and the lid portion and externally fitted on a branched part branched from the wiring harness accommodated in the accommodating portion; and
a side portion on a tip side of a side wall of the accommodating portion and a side portion on an end side of the lid portion are placed one over the other with the branched part exterior material sandwiched between the side portion on the tip side of the side wall of the accommodating portion in the soft portion of the accommodating portion and the side portion on the end side of the lid portion.
